(19) United States
(12) Patent Application Publication
(10) Pub. No.: US 2018/0336575 A1
(43) Pub. Date: Nov. 22, 2018

(54) GRAPHICAL REPRESENTATIONS OF REAL-TIME SOCIAL EMOTIONS

(71) Applicant: International Business Machines Corporation, Armonk, NY (US)

(72) Inventors: Inseok HWANG, Austin, TX (US); Su LIU, Austin, TX (US); Eric J. ROZNER, Austin, TX (US); Chin Ngai SZE, Austin, TX (US)

(21) Appl. No.: 15/596,967

(22) Filed: May 16, 2017

(51) Int. Cl. G06Q 30/02; G06F 17/28

(52) U.S. Cl. CPC G06Q 30/0201; G06F 17/28

(57) ABSTRACT

Systems, methods, and computer program products to perform an operation comprising receiving a request to generate a graphical representation of a collective set of emotions of a plurality of users in a location, receiving data describing the plurality of users from a plurality of mobile devices proximate to the location, extracting, based at least in part on natural language processing and biometric data included in the received data, a plurality of emotions from the received data, and generating the graphical representation comprising a map of the location and an indication of each of the plurality of extracted emotions.

### BACKGROUND

The present disclosure relates to computer software, and more specifically, to computer software which provides graphical representations of real-time social emotions.

Modernly, users communicate via social media to exchange information, share thoughts, express emotions, and convey their experiences. However, individual users and/or groups of users often have different emotions at any given time. Often, these users and/or groups of users have different emotions, even though they are participating in the same event and/or are in the same location.

### SUMMARY

In one embodiment, a method comprises receiving a request to generate a graphical representation of a collective set of emotions of a plurality of users in a location, receiving data describing the plurality of users from a plurality of mobile devices proximate to the location, extracting, based at least in part on natural language processing and biometric data included in the received data, a plurality of emotions from the received data, and generating the graphical representation comprising a map of the location and an indication of each of the plurality of extracted emotions.

In another embodiment, a system comprises a processor and a memory storing instructions, which when executed by the processor, performs an operation comprising receiving a request to generate a graphical representation of a collective set of emotions of a plurality of users in a location, receiving data describing the plurality of users from a plurality of mobile devices proximate to the location, extracting, based at least in part on natural language processing and biometric data included in the received data, a plurality of emotions from the received data, and generating the graphical representation comprising a map of the location and an indication of each of the plurality of extracted emotions.

In another embodiment, a computer-readable storage medium has computer-readable program code embodied therewith, the computer-readable program code executable by a processor to perform an operation comprising receiving a request to generate a graphical representation of a collective set of emotions of a plurality of users in a location, receiving data describing the plurality of users from a plurality of mobile devices proximate to the location, extracting, based at least in part on natural language processing and biometric data included in the received data, a plurality of emotions from the received data, and generating the graphical representation comprising a map of the location and an indication of each of the plurality of extracted emotions.

### BRIEF DESCRIPTION OF THE SEVERAL VIEWS OF THE DRAWINGS

FIGS. 1A-1D illustrate example graphical representations of real-time social emotions, according to various embodiments.

FIG. 2 depicts an example system architecture which provides graphical representations of real-time social emotions, according to one embodiment.

FIG. 3 depicts an example graphical user interface to request a graphical representation of real-time social emotions, according to one embodiment.

FIG. 4 is a flow chart illustrating an example method to provide graphical representations of real-time social emotions, according to one embodiment.

FIG. 5 is a flow chart illustrating an example method to receive emotion data from users, according to one embodiment.

FIG. 6 is a flow chart illustrating an example method to analyze emotion data, according to one embodiment.

FIG. 7 is a flow chart illustrating an example method to generate a social graph based on analyzed emotion data, according to one embodiment.

FIG. 8 is a flow chart illustrating an example method to generate an emotion map, according to one embodiment.

FIG. 9 is a block diagram illustrating an example system which provides graphical representations of real-time social emotions, according to one embodiment.

### DETAILED DESCRIPTION

Embodiments disclosed herein provide a service which generates graphical representations of real-time social emotions. The graphical representations may include maps which reflect the emotions expressed by different users and/or groups of users at a particular location, and social graphs which reflect the spread of emotions among users and/or groups of users. For example, a user may wish to view a map reflecting the emotions of users attending a parade. In response, embodiments disclosed herein analyze data from the mobile devices of different users and social media platforms to identify different emotions of the users. As part of the analysis, each user may be associated with one or more emotions, groups of users, and contexts. Based on the analysis, embodiments disclosed herein generate a map reflecting the different emotions expressed by the users and groups of users. Furthermore, in some embodiments, one or more social graphs reflecting the spread of emotions between users and groups of users are generated.

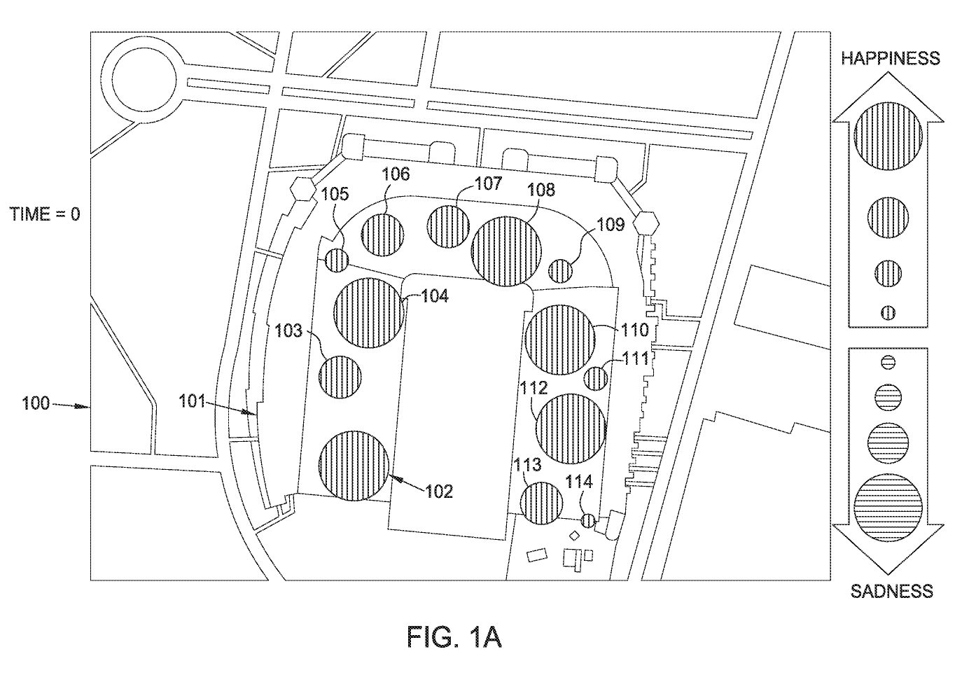

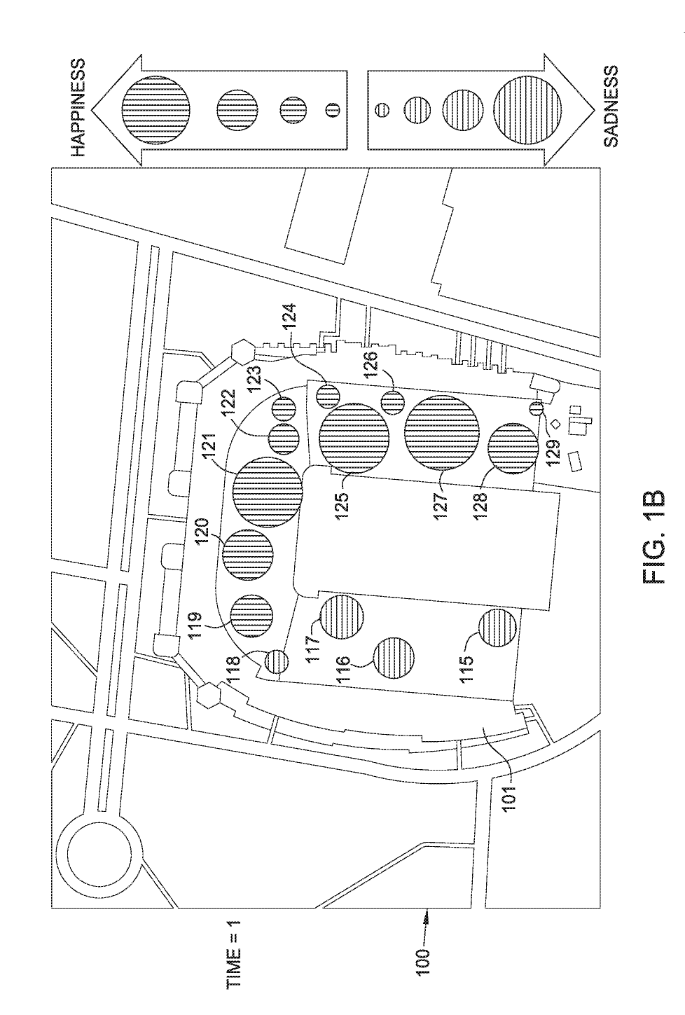

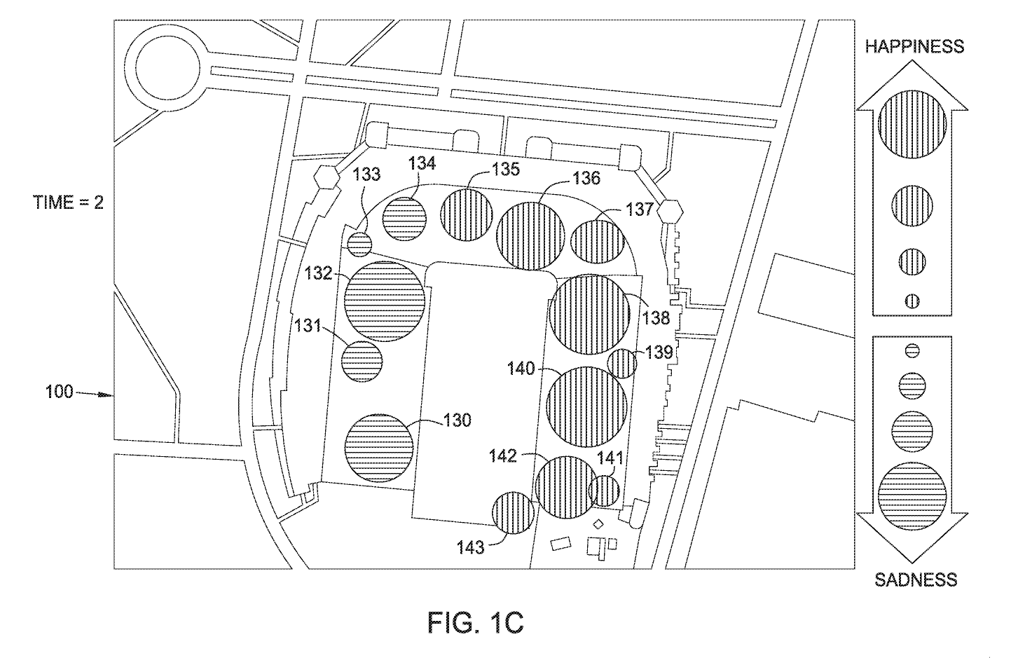

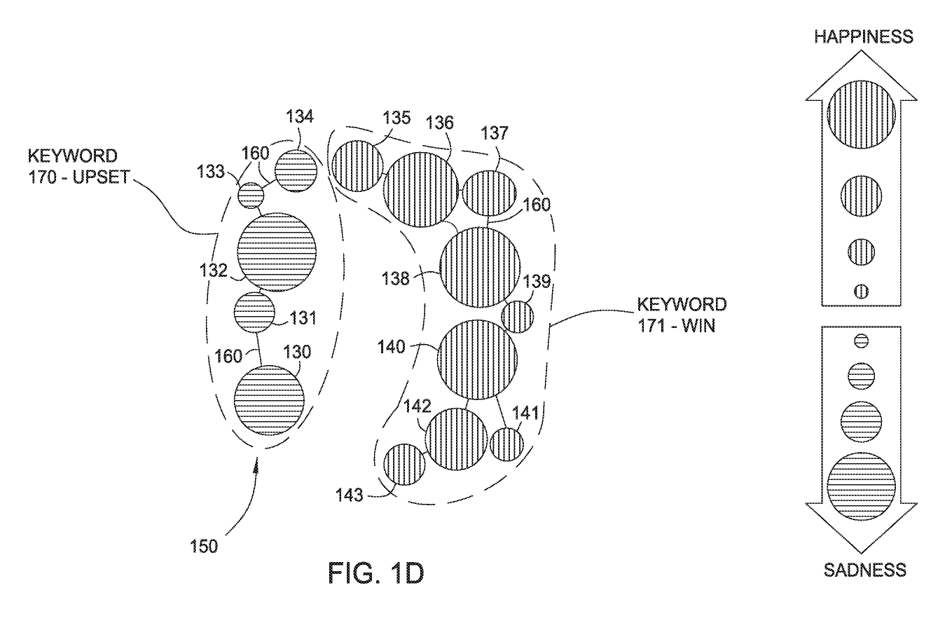

FIG. 1A illustrates an example emotion map 100 which is a graphical representation of real-time social emotions, according to one embodiment. As shown, the emotion map 100 depicts a stadium 101 where many people can gather to watch an event, such as a sporting event, concert, and the like. As shown, the emotion map 100 reflects the emotions of groups 102-114 of users in the stadium 101 at an example time of 0. Each group 102-114 includes one or more people whose mobile devices (not pictured) have provided data for analysis. The emotions of each group 102-114 are generated by analyzing the sentiment expressed by users via their mobile devices (e.g., via social media publications, text messages, chat logs, and the like), and/or analyzing biometric data provided by one or more biometric sensors monitoring the users. The size of the circles representing the groups 102-114 may be based on a determined emotion index (e.g., a score computed for the users, where the score represents a degree of the emotion for the users in the group) and/or a number of users in the groups 102-114. Therefore, a larger circle representing the groups 102-114 reflects a higher degree of a particular emotion and/or a greater number of people expressing the emotion.

In one embodiment, the emotion map 100 is generated responsive to a user request specifying the stadium 101 as a location and the emotions of “happiness” and “sadness” as emotion types. As shown, therefore, the emotion map 100 groups users into groups of some degree of happiness and/or sadness. In the example depicted in FIG. 1A, the users are all expressing some degree of happiness, as, for example, the users are all happy to be at the stadium 101 to view a sporting event (e.g., before the event begins). Generally, therefore, the groups 102-114 reflect that embodiments disclosed herein analyzed the emotions expressed by the associated users, and determined (e.g., based on natural language processing (NLP), keyword association, emoji, emotional expression stickers, emoticon detection, biometric signals, etc.) that the users of each group 102-114 were expressing some degree of happiness.

FIG. 1B depicts the emotion map 100 generated at an example time of 1, subsequent to the time of 0 of FIG. 1A. For example, time of 1 may correspond to some point after the sporting event has started, and one team has taken the lead. As shown, the emotion map 100 now includes groups 115-129, of which groups 115-119 are associated with some degree of sadness (e.g., supporters of the team not in the lead), while groups 120-129 are associated with some degree of happiness (e.g., supporters of the team in the lead). By analyzing the user data (e.g., data from the mobile devices of each user, chat logs, social media publications of the users, and the like), embodiments disclosed herein detect that the users of groups 115-119 are sad, and the users of groups 120-129. For example, users at the stadium 101 may send messages to friends via a social media messaging platform. Embodiments disclosed herein may analyze the messages to identify the emotion of sadness in the messages of users in groups 115-119, while identifying the emotion of happiness in the messages of users in groups 120-129.

FIG. 1C depicts the emotion map 100 generated at an example time of 2, subsequent to the time of 1 of FIG. 1B. For example, time of 2 may correspond to a time subsequent to the completion of the sporting event at the stadium 101. As such, the emotion map 100 now depicts groups 130-143, of which groups 130-134 are expressing some degree of sadness, while groups 135-143 are expressing some degree of happiness. For example, the users of groups 135-143 are fans of the winning team, and analysis of the data from the mobile devices of these users indicates each user is happy that their team won the sporting event. Conversely, the users of groups 130-134 are fans of the losing team, and the analysis of the data from the mobile devices of these users indicates that each user is sad that their team did not win the sporting event.

FIG. 1D depicts an example social graph 150 which reflects relationships 160 between the groups of users 130-143. Generally, the relationship lines 160 of the social graph 150 reflect the spread of emotions and/or keywords between different users communicating via messaging platforms. Therefore, as shown, the groups 130-134 are associated with a keyword 170 of “upset” indicating that the users believe their team was upset during the sporting event. For example, the users in the groups 130-134 may send messages to each other stating “what an upset”, or “I can't believe that upset”. Similarly, the groups 135-143 are associated with a keyword 171 of “win”, reflecting that the users within each group 135-143 have communicated this keyword to at least one other person via a messaging platform (e.g., members of a different group 135-143).

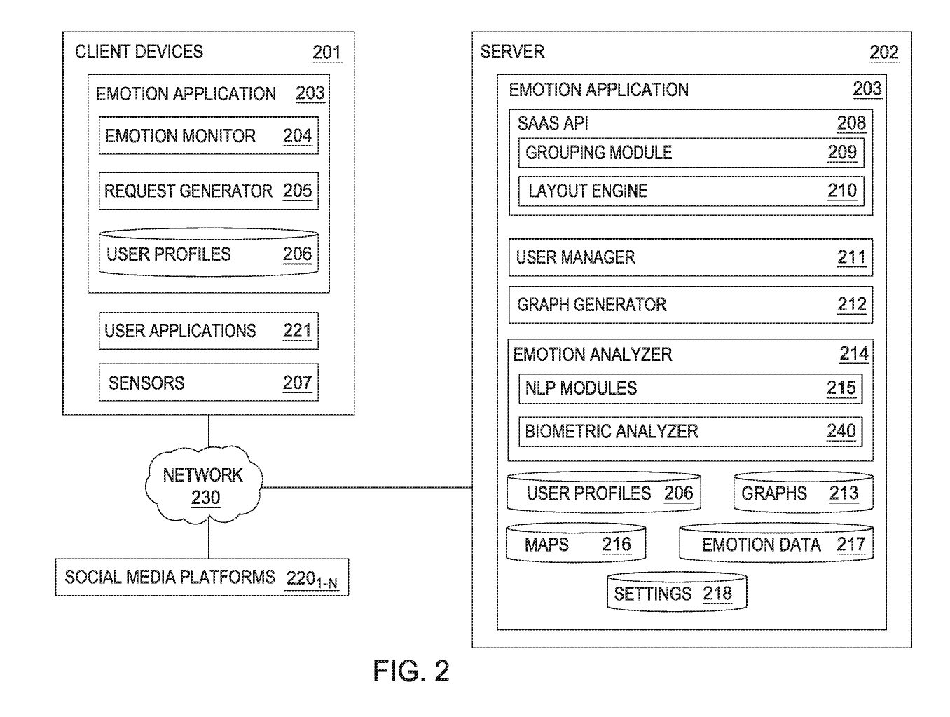

FIG. 2 depicts an example system architecture 200 which provides graphical representations of real-time social emotions, according to one embodiment. As shown, the system 200 includes a plurality of client devices 201 and a server 202. The client devices 201 include any type of mobile device, such as a smartphone, laptop, tablet computer, and the like. As shown, each client device 201 and the server 202 executes an instance of an emotion application 203, which is configured to generate graphical representations of user emotions, such as the emotion maps 100 of FIGS. 1A-1C, and the social graph 160 of FIG. 1D. Although depicted as a single application, the instances of the emotion application 203 on the client devices 201 and server 202 may take different forms. For example, each component of the instances of the emotion application 203 on the client devices 201 and server 202 may be separate modules, rather than being integrated into the emotion application 203.

As shown, the instances of the emotion application 203 on the client devices 201 include an emotion monitor 204, a request generator 205, and a data store of user profiles 206. The request generator 205 of a given client device 201 is configured to transmit requests to the instance of the emotion application 203 executing on the server 202 to create a graphical representation of user emotions. The request may specify a location, one or more emotion types (e.g., happiness, sadness), and grouping criteria (e.g., group people based on job titles, sports team associations, alma maters, current context activities, etc.). For example, the instance of the emotion application 203 on the server 201 may receive a request to analyze emotions in the stadium 101 of FIGS. 1A-1C, specifying happiness and sadness as emotions, and people watching the sporting event at the stadium 101 as the current context activity. As such, the instance of the emotion application 203 on the server 202 may send an indication of the request to the instances of the emotion application 203 on the client devices 201. In response, the instance of the emotion application 203 on the client devices 201 may determine (e.g., based on data from a global positioning system (GPS) module, not pictured) that the respective client device 201 is located proximate to the requested location (e.g., the stadium 101). The client devices 201 that are within a predefined distance of the requested location may then gather and transmit data indicative of the emotions of the associated user.

The emotion monitor 204 is generally configured to monitor the emotions of an associated user of the respective client device 201 based on an analysis of data created by the user via one of the user applications 221, data in the user profile 206, and/or data provided by the sensors 207. The user applications 221 include messaging applications, social media applications, and the like, one or more of which may communicate with the social media platforms 220 via the network 230. The user profiles 206 store data associated with the user, such as biographic information, preference information, account information for social media services, account information for the user applications 221, and the like. In at least one embodiment, the user profiles 206 store chat logs generated by the user applications 221. The sensors 207 are representative of any type of sensor which monitors a biometric attribute of the user, such as heartrate sensors, blood pressure sensors, and any other type of sensor. Therefore, for example, the heartrate sensor 207 may provide heartrate data indicating the user's pulse is elevated. The emotion monitor 204 may then analyze messages sent by the user via the user applications 221 to detect keywords (e.g. via NLP) such as “nervous”, “stressed”, and the like. The user profile 206 may indicate that the user is an alumnus of a university participating in the sporting event at the stadium 101. As such, the emotion monitor 204 may determine that the user is nervous. In at least one embodiment, the emotion monitor 204 computes an emotion score for the associated user, where the emotion score reflects an emotion expressed by the user. For example, the emotion monitor 204 may be configured to detect ten different types of emotions. Each of the ten emotions may be associated with a respective range of values for the emotion score (e.g., happiness is defined as a score of 91-100 on a scale from 0-100). The instance of the emotion application 203 may then transmit an indication of the computed emotion score, along with any other data from the client device 201 (e.g., location data, data from the sensors 207 and user applications 221, user profile data, messaging data, and the like) to the instance of the emotion application 203 on the server 202.

As shown, the instance of the emotion application 203 on the server 202 includes a software as a service (SaaS) application programming interface (API) 208, a user manager 211, a graph generator 212, and an emotion analyzer 214. The SaaS API 208 is a cloud-based API that provides access to the services provided by the emotion application 203. As shown, the SaaS API 208 includes a grouping module 209 and a layout engine 210. The grouping module 209 is configured to categorize users expressing similar emotions into groups. The layout engine 210 is configured generate maps 216 (such as the maps 100 of FIGS. 1A-1C) by overlaying emotional density on a digital map of the requested location based on the analysis performed by the instances of the emotion application 203 executing on the client devices 201 and the server 202.

The user manager 211 is a module which manages the emotions extracted by the emotion analyzer 214 for each user, categorizing the respective user into one or more emotional groups. For example, the user manager 211 may categorize users based on detected emotions, locations, times, and any other personal information. In at least one embodiment, the groups are based on an activity context, such as those people who are driving on a highway, running in a race while listening to a podcast, watching a movie, and the like. The user manager 211 is further configured to identify users based on personal profiles, account information, and/or collected emotion data.

The graph generator 212 is configured to generate the graphs 213, such as the social graph 160 of FIG. 1D. The graph generator 212 analyzes the message logs received from the client devices 201 and/or the social media platforms 220_{1-N} to identify keywords and the spread of such keywords between users. For example, if a first user sends a first keyword in a message to a second user, and the second user sends a message with the first keyword to a third user, the graph generator 212 identifies the keyword and the flow of the keyword from the first user, to the second user, to the third user. The graph generator 212 may then generate the graphs 213 which reflect keywords and the relationships between the spread of keywords and the spread of emotions between users.

The emotion analyzer 214 analyzes user data (e.g., data from the user profiles 206, communication data, data from the social media platforms 220_{1-N}, data from the sensors 207, and the like) to identify one or more emotions of the associated user. The emotion analyzer 214 includes NLP modules 215 and a biometric analyzer 240. The NLP modules 215are natural language processing modules that extract emotion types and emotion levels (e.g., very happy, somewhat happy, etc.). The biometric analyzer 240 is configured to analyze data from the sensors 207 and extract emotions from the sensor data. For example, the biometric analyzer 240 may map ranges of heart rates to respective emotions, associate perspiration levels with emotions, and the like.

As shown, the server 202 further includes the emotion data 217 and a data store of settings 218. The emotion data 217 stores emotion data for a plurality of different users, and is used by the layout engine 210 to generate the maps 216. The emotion data 217 may generally include an indication of a time, a user, one or more detected emotions, and a computed emotion score for each emotion of the user. The settings 218 stores rules and settings for the emotion application 203. For example, the settings 218 may include grouping criteria for categorizing users into groups. The grouping criteria include, without limitation, education, hobbies, gender, age, job titles, and the like. Therefore, the settings 218 may define a female alumna association as females who are graduates of a particular university. In at least one embodiment, service providers include a predefined list of criteria so that users can select the criteria for a given group definition. The settings 218 further include definitions of emotion types, such as happiness, sadness, etc. Generally, the emotion types are used to provide a standardized catalog and rules for defining and detecting emotions. One example of emotion type definitions includes the International Affective Picture System (IAPS). Based on the standardized catalog and rules, the emotion analyzer 214 may accurately detect different emotions for different users.

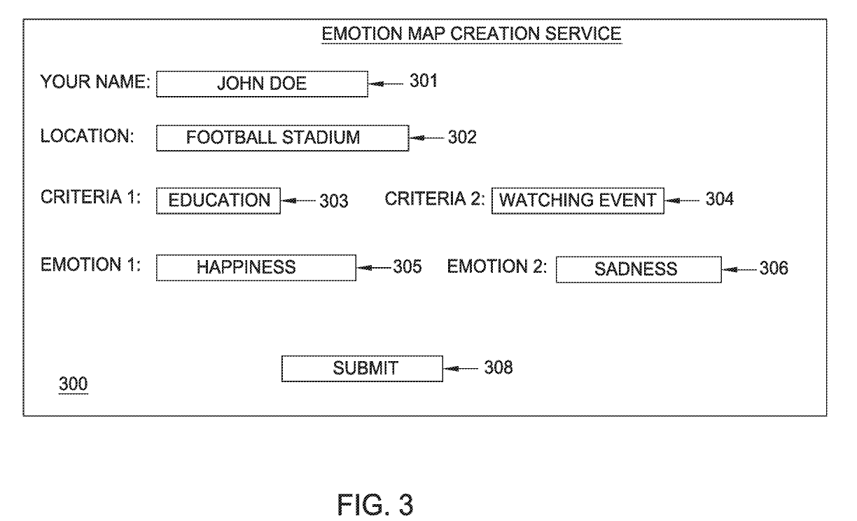

FIG. 3 depicts an example graphical user interface (GUI) 300 allowing users to request a graphical representation of real-time social emotions, according to one embodiment. In at least one embodiment, the request generator 205 of the emotion application 203 provides the GUI 300. As shown, the GUI 300 includes fields 301-306 for receiving user input. Field 301 corresponds to a user name (or other user identifier, such as an account identifier), a location field 302 for specifying a location for which to generate an emotion map, criteria fields 303, 304 which specify criteria for group membership, and emotion fields 305, 306 for desired emotions. Although the fields 301-306 are depicted, the GUI 300 may generally include any number and type of fields for receiving user input. In the example shown in FIG. 3, a user named John Doe has specified to generate an emotion map for a football stadium. The user has further specified that users should be grouped based on education (e.g., alma mater) and whether they are watching an event at the football stadium. The user has further specified that the emotion map should reflect happiness and sadness of users. In at least one embodiment, the grouping criteria and emotions are selected from a plurality of predefined criteria and emotions, respectively.

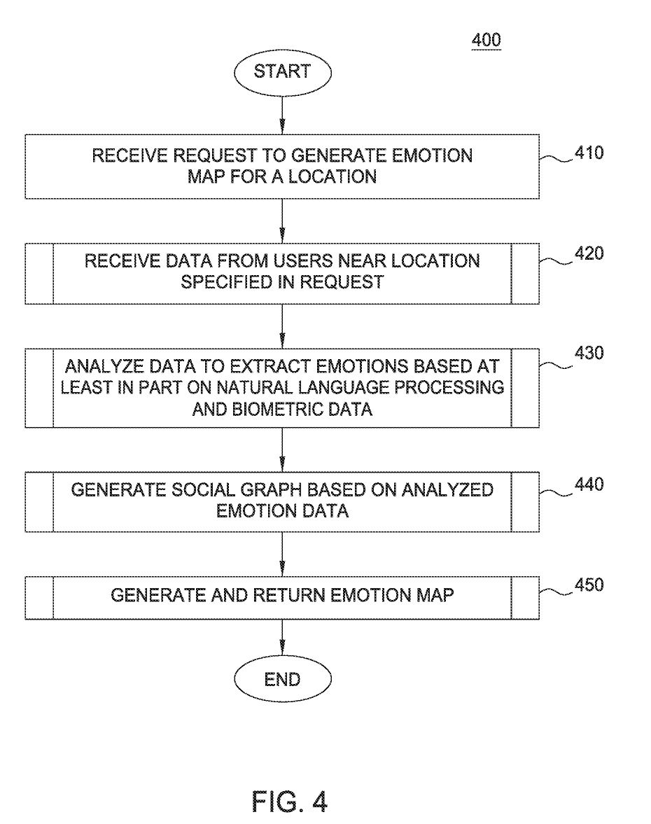

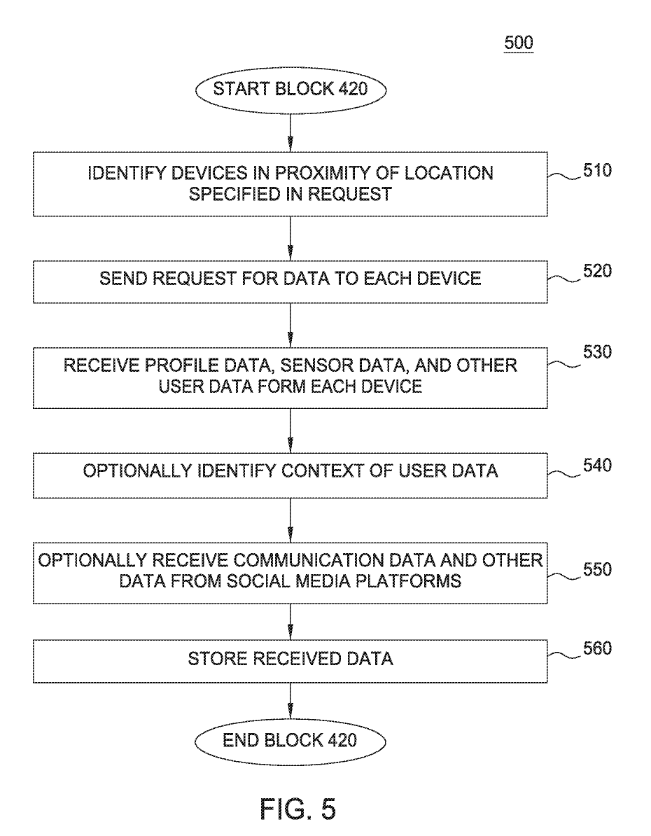

FIG. 4 is a flow chart illustrating an example method 400 to provide graphical representations of real-time social emotions, according to one embodiment. As shown, the method 400 begins at block 410, where the SaaS API 208 on the server 202 receives a request to generate an emotion map, e.g., from the GUI 300 and/or the request generator 205 of a client device 201. As discussed, the request may specify a desired location, emotions to be detected, user grouping criteria, and the like. At block 420, described in greater detail with reference to FIG. 5, the instance of the emotion application 203 executing on the server 202 receives data from each client device 201 determined to be within a predefined distance of the location specified in the request. The emotion application 203 executing on the server 202 may further receive data from the social media platforms 220_{1-N} describing each user of the client devices 201 that are within the predefined distance of the location specified in the request. For example, at block 420, the emotion application 203 executing on the server 202 receives biometric data from the sensors 207, message data/logs, emoticons transmitted by the user (e.g., emojis, emotion expression stickers, etc.), social media publications, data from the user profiles 206, and the like.

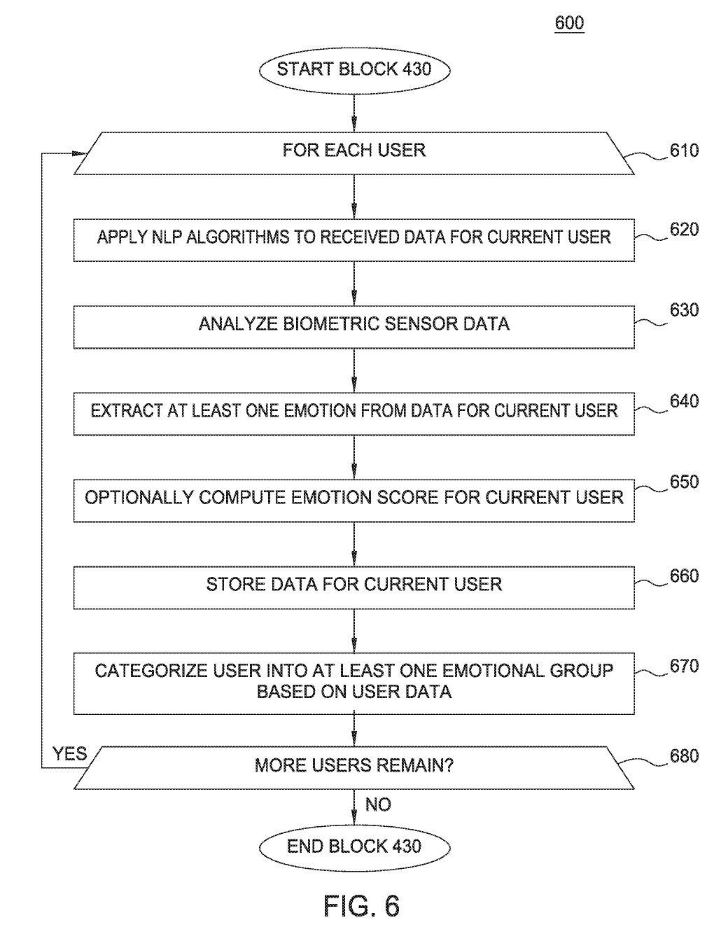

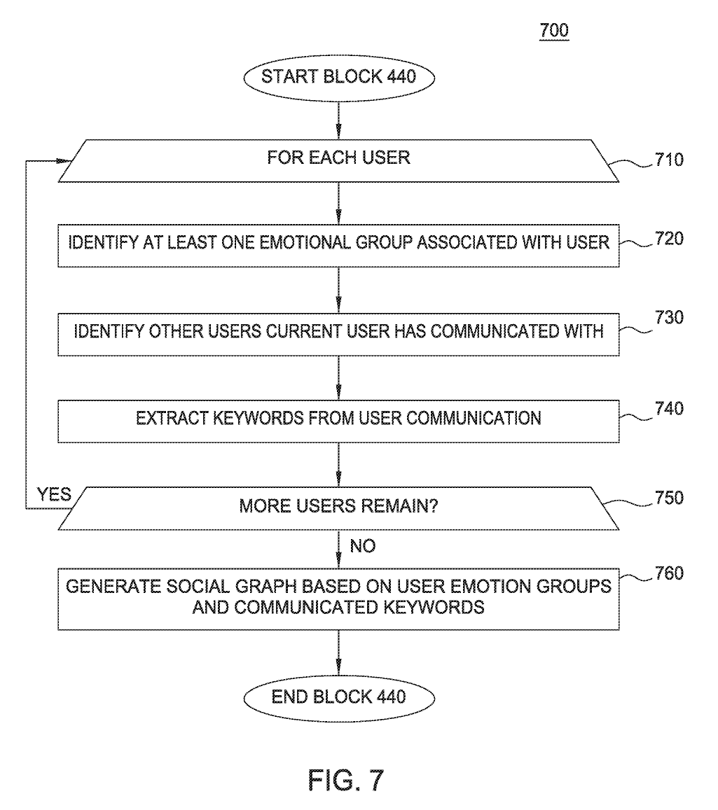

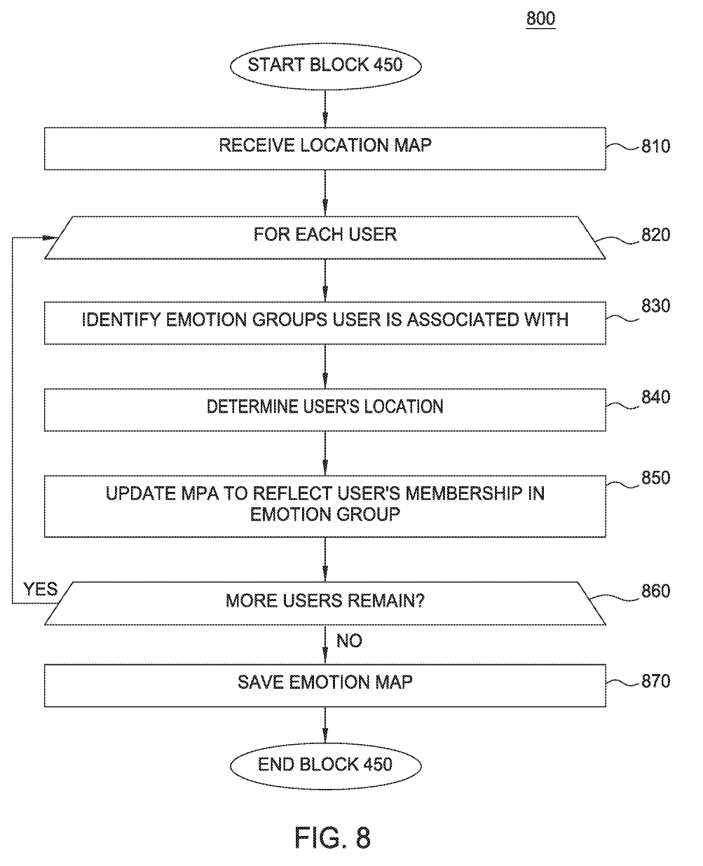

At block 430, described in greater detail with reference to FIG. 6, the emotion application 203 executing on the server 202 analyzes the data received at block 420 to extract emotions of the associated users. The emotions extracted at least in part based on the NLP modules 215, which may identify the emotions in the text transmitted by a given user, and/or the biometric analyzer 240, which analyzes biometric data captured by the sensors 207. At block 440, described in greater detail with reference to FIG. 7, the emotion application 203 executing on the server 202 generates a social graph based on the analyzed emotion data. The social graph reflects the flow of keywords and/or emotions between users. In at least one embodiment, the generated social graph is stored in the graphs 213. At block 450, described in greater detail with reference to FIG. 8, the emotion application 203 executing on the server 202 generates and returns an emotion map to the requesting user. Generally, the emotion map indicates relative frequencies of each requested emotion among users in the requested location. In at least one embodiment, the generated emotion map is stored in the maps 216.

FIG. 5 is a flow chart illustrating an example method 500 corresponding to block 420 to receive emotion data from users, according to one embodiment. As shown, the method 500 begins at block 510, where the instance of the emotion application 203 executing on the server 202 identifies devices in proximity of the location specified in the request. For example, the instance of the emotion application 203 executing on the server 202 may send a broadcast message to all instances of the instance of the emotion application 203 executing on the client devices 201 with coordinates of the requested location. Those client devices 201 may then respond with an indication that they are within a predefined distance of the requested location. In another embodiment, the instances of the emotion application 203 on the client devices 201 passively collect and transmit data to the instance of the emotion application 203 on the server 202. At block 520, the instance of the emotion application 203 executing on the server 202 sends a request for data to each client device identified at block 510. At block 530, the instance of the emotion application 203 executing on the server 202 receives data from the devices identified at block 510. Generally, the received data includes data from the user profiles 206, data from the sensors 207, and other user data from each device, such as chat logs, messaging logs, captured images, and the like.

At block 540, the instance of the emotion application 203 executing on the server 202 optionally determines an activity context of each user associated with the client devices 201 identified at block 510. For example, the instance of the emotion application 203 executing on the server 202 may determine that users are watching a parade, speech, or rally, that some users are driving, flying, or taking a bus, and other users are at home watching TV. Generally, the instance of the emotion application 203 executing on the server 202 uses the context as a criterion by which to group users. At block 550, the instance of the emotion application 203 executing on the server 202 receives data from other data sources, such as the social media platforms 220_{1-N}. This data may include social media posts, blog posts, chat logs, and the like. At block 560, the instance of the emotion application 203 executing on the server 202 stores the received data (e.g., in a user profile 206).

FIG. 6 is a flow chart illustrating an example method 600 corresponding to block 430 to analyze emotion data, according to one embodiment. As shown, the method 600 begins at block 610, where the emotion analyzer 214 executes a loop including blocks 620-670 for each user associated with a client device 201 identified at block 510. At block 620, the emotion analyzer 214 applies the NLP modules 215 to the received data for the current user. Generally, the NLP modules 215 analyze chat logs, text messages, social media publications, and the like, to extract user sentiment (e.g., emotions) from the text data. At block 630, the biometric analyzer 240 analyzes the biometric data received from the sensors 207. Generally, the biometric analyzer 240 may reference mappings between values from the sensors 207 and an emotion in the settings 218. For example, if a sweat gland sensor 207 returns data indicating a user is lightly perspiring, the biometric analyzer 240 may reference the settings 218 to identify an associated emotion (e.g., anxiousness).

At block 650, the emotion analyzer 214 (and/or a component thereof) extracts at least one emotion from the received data for the current user. For example, the emotion analyzer 214 may identify emoticons sent by the user, which may be mapped in the settings 218 to a corresponding emotion. Similarly, the emotion analyzer 214 may analyze images to identify emotions expressed on the faces of people depicted in the images. At block 660, the emotion analyzer 214 optionally computes an emotion score for the user based on the analysis of the textual data by NLP modules 215, the non-textual data, and the sensor data 207. At block 660, the emotion analyzer 214 stores the data for the current user. At block 670, the emotion analyzer 214 associates the current user with at least one group based on the detected emotions, the emotion score (and associated emotion), and the grouping criteria. For example, the emotion analyzer 214 may group the user into a group of happy engineers enjoying dinner at a local restaurant. In addition, the emotion analyzer 214 may group users in multiple dimensions. For example, the emotion analyzer 214 may group users into multiple groups based on the personal characteristics of each user defined in the settings 218 (e.g., education, hobbies, age, job titles, and the like). In at least one embodiment, the associations are stored in the respective user profile 206 of the current user. At block 680, the emotion analyzer 214 determines whether more users remain. If more users remain, the emotion analyzer 214 returns to block 610. Otherwise, the method 600 ends.

FIG. 7 is a flow chart illustrating an example method 700 corresponding to block 440 to generate a social graph based on analyzed emotion data, according to one embodiment. As shown, the method 700 begins at block 710, where the graph generator 212 executes a loop including blocks 720-740 for each user identified at block 510. At block 720, the graph generator 212 identifies at least one emotional group that the current user is associated with (e.g., happy, sad, engineer, etc.). At block 730, the graph generator 212 identifies other users the current user has communicated with, e.g., based on chat logs, messages, emails, social media posts, and the like. At block 740, the graph generator 212 extracts keywords from the communications identified at block 740. In at least one embodiment, the graph generator 212 invokes the NLP modules 215 to extract the keywords, and associates the keywords with any user who was a recipient of the keyword. At block 750, the graph generator 212 determines whether more users remain. If more users remain, the graph generator 212 returns to block 710, otherwise, the graph generator 212 proceeds to block 760. At block 760, the graph generator 212 generates the social emotion graph based on the emotion groups and communicated keywords.

FIG. 8 is a flow chart illustrating an example method 800 corresponding to block 450 to generate an emotion map, according to one embodiment. As shown, the method 800 begins at block 810, where the layout engine 210 receives a map of the location specified in the request received at block 410. In at least one embodiment, the layout engine 210 receives the map based on coordinates specified in the request, e.g., from an online map provider. At block 820, the layout engine 210 executes a loop including blocks 830-860 for each user identified at block 510. At block 830, the layout engine 210 identifies each emotion group the current user is associated with (e.g., specified in the corresponding user profile 206). At block 840, the layout engine 210 determines the user's current location, which may be specified in the data received at block 530. Alternatively, the layout engine 210 may send a request to the device for an updated current location. At block 850, the layout engine 210 updates the map to reflect the user's location and membership in each emotion group. For example, the settings 218 may specify shapes, colors, and other settings for drawing the emotion maps. The layout engine 210 may then use the settings to render the appropriate depiction of the current user and the associated group memberships. For example, the layout engine 210 may depict a sad user using a first color, and a happy user using a second color. At block 860, the layout engine 210 determines whether more users remain. If more users remain, the layout engine 210 returns to block 810. Otherwise, the layout engine 210 proceeds to block 870, where the layout engine 210 saves the generated map to the maps 216.

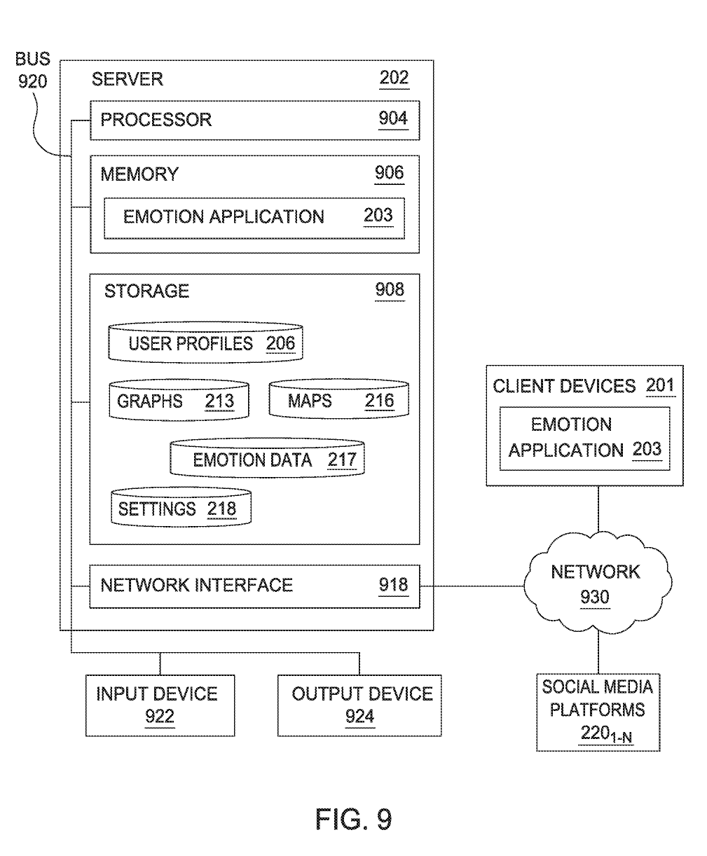

FIG. 9 is a block diagram illustrating an example system 900 which provides graphical representations of real-time social emotions, according to one embodiment. The networked system 900 includes the server 202. The server 202 may also be connected to other computers via a network 930. In general, the network 930 may be a telecommunications network and/or a wide area network (WAN). In a particular embodiment, the network 930 is the Internet.

The server 202 generally includes a processor 904 which obtains instructions and data via a bus 920 from a memory 906 and/or a storage 908. The server 202 may also include one or more network interface devices 918, input devices 922, and output devices 924 connected to the bus 920. The server 202 is generally under the control of an operating system (not shown). Examples of operating systems include the UNIX operating system, versions of the Microsoft Windows operating system, and distributions of the Linux operating system. (UNIX is a registered trademark of The Open Group in the United States and other countries. Microsoft and Windows are trademarks of Microsoft Corporation in the United States, other countries, or both. Linux is a registered trademark of Linus Torvalds in the United States, other countries, or both.) More generally, any operating system supporting the functions disclosed herein may be used. The processor 904 is a programmable logic device that performs instruction, logic, and mathematical processing, and may be representative of one or more CPUs. The network interface device 918 may be any type of network communications device allowing the server 202 to communicate with other computers via the network 930.

The storage 908 is representative of hard-disk drives, solid state drives, flash memory devices, optical media and the like. Generally, the storage 908 stores application programs and data for use by the server 202. In addition, the memory 906 and the storage 908 may be considered to include memory physically located elsewhere; for example, on another computer coupled to the server 202 via the bus 920.

The input device 922 may be any device for providing input to the server 202. For example, a keyboard and/or a mouse may be used. The input device 922 represents a wide variety of input devices, including keyboards, mice, controllers, and so on. Furthermore, the input device 922 may include a set of buttons, switches or other physical device mechanisms for controlling the server 202. The output device 924 may include output devices such as monitors, touch screen displays, and so on.

As shown, the memory 906 contains an instance of the emotion application 203 of the server 202 from FIG. 2. As shown, the storage 908 contains the user profiles 206, graphs 213, maps 216, emotion data 217, and settings 218. As described above, the server 202 instance of the emotion application 203 is configured to process user requests to generate an emotion map and/or social graph reflecting user emotions in public. The instance of the emotion application 203 on the server 202 communicates with the social media platforms 220_{1-N} and the instances of the emotion application 203 on the client devices 201 to receive data describing each user, which includes messages, emoticons, emoji, emotional expression stickers, biometric data of the user, images, and other data from which the emotion application 203 can extract emotions from. The instance of the emotion application 203 on the server 202 may then generate the graphs 213 and the maps 216 based on the received data.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the foregoing, reference is made to embodiments presented in this disclosure. However, the scope of the present disclosure is not limited to specific described embodiments. Instead, any combination of the recited features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the recited aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications or related data available in the cloud. For example, the emotion application 203 could execute on a computing system in the cloud. In such a case, the emotion application 203 may store emotion maps 216 and user profiles 206 for a plurality of users at a storage location in the cloud. Doing so allows a user to access this information from any computing system attached to a network connected to the cloud (e.g., the Internet).

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
receiving a request to generate a graphical representation of a collective set of emotions of a plurality of users in a location;
receiving data describing the plurality of users from a plurality of mobile devices proximate to the location;
extracting, based at least in part on natural language processing and biometric data included in the received data, a plurality of emotions from the received data; and
generating the graphical representation comprising a map of the location and an indication of each of the plurality of extracted emotions.

2. The method of claim 1, wherein the data describing the plurality of users comprises: (i) messages generated by the users, (ii) user profiles of the plurality of users, (iii) the biometric data generated by a plurality of biometric sensors, and (iv) social media publications generated by the plurality of users.

3. The method of claim 2, further comprising:
computing an emotion score for each of the plurality of users, wherein the emotion score is based on: (i) the natural language processing applied to the received data of each user, and (ii) the biometric sensor data of each user; and
associating the emotion score with a respective emotion of the plurality of emotions based on a mapping between a range of emotion scores and each respective emotion.

4. The method of claim 3, wherein the graphical representation further comprises a generated graph reflecting flow of a keyword from at least a first user of the plurality of users to a second user of the plurality of users, wherein the keyword is associated with one of the plurality of emotions extracted from the received data describing the plurality of users.

5. The method of claim 4, wherein the request further specifies: (i) a first emotion of the plurality of emotions and (ii) a first grouping criterion of a plurality of grouping criteria, the method further comprising:
identifying a first subset of the plurality of users based on: (i) each user in the first subset having an attribute satisfying the first grouping criterion, and (ii) each user in the first subset having the first emotion extracted from the respective user data;
grouping each user of the first subset into a group defined by the first grouping criterion; and
outputting an indication of the first group and the first emotion on the emotion map.

6. The method of claim 1, further comprising:
prior to receiving the data describing the users, transmitting an indication to provide data describing the users to each of the plurality of mobile devices, wherein the transmitted indication specifies the location received in the request, wherein each of the plurality of mobile devices is configured to determine whether the respective device is within a predefined distance of the location and transmit the data describing the users upon determining that the respective device is within the predefined distance of the location.

7. The method of claim 1, wherein the request is received by an instance of a software as a service (SaaS) application programming interface (API) executing in a cloud computing environment.

8. A computer program product, comprising:
a computer-readable storage medium having computer readable program code embodied therewith, the computer readable program code executable by a processor to perform an operation comprising:
receiving a request to generate a graphical representation of a collective set of emotions of a plurality of users in a location;
receiving data describing the plurality of users from a plurality of mobile devices proximate to the location;
extracting, based at least in part on natural language processing and biometric data included in the received data, a plurality of emotions from the received data; and
generating the graphical representation comprising a map of the location and an indication of each of the plurality of extracted emotions.

9. The computer program product of claim 8, wherein the data describing the plurality of users comprises: (i) messages generated by the users, (ii) user profiles of the plurality of users, (iii) the biometric data generated by a plurality of biometric sensors, and (iv) social media publications generated by the plurality of users.

10. The computer program product of claim 9, the operation further comprising:
computing an emotion score for each of the plurality of users, wherein the emotion score is based on: (i) the natural language processing applied to the received data of each user, and (ii) the biometric sensor data of each user; and
associating the emotion score with a respective emotion of the plurality of emotions based on a mapping between a range of emotion scores and each respective emotion.

11. The computer program product of claim 10, wherein the graphical representation further comprises a generated graph reflecting flow of a keyword from at least a first user of the plurality of users to a second user of the plurality of users, wherein the keyword is associated with one of the plurality of emotions extracted from the received data describing the plurality of users.

12. The computer program product of claim 11, wherein the request further specifies: (i) a first emotion of the plurality of emotions and (ii) a first grouping criterion of a plurality of grouping criteria, the operation further comprising:
identifying a first subset of the plurality of users based on: (i) each user in the first subset having an attribute satisfying the first grouping criterion, and (ii) each user in the first subset having the first emotion extracted from the respective user data;
grouping each user of the first subset into a group defined by the first grouping criterion; and
outputting an indication of the first group and the first emotion on the emotion map.

13. The computer program product of claim 8, the operation further comprising:
prior to receiving the data describing the users, transmitting an indication to provide data describing the users to each of the plurality of mobile devices, wherein the transmitted indication specifies the location received in the request, wherein each of the plurality of mobile devices is configured to determine whether the respective device is within a predefined distance of the location and transmit the data describing the users upon determining that the respective device is within the predefined distance of the location.

14. The computer program product of claim 8, wherein the request is received by an instance of a software as a service (SaaS) application programming interface (API) executing in a cloud computing environment.

15. A system, comprising:
a processor; and
a memory storing one or more instructions which, when executed by the processor, performs an operation comprising:
receiving a request to generate a graphical representation of a collective set of emotions of a plurality of users in a location;
receiving data describing the plurality of users from a plurality of mobile devices proximate to the location;
extracting, based at least in part on natural language processing and biometric data included in the received data, a plurality of emotions from the received data; and
generating the graphical representation comprising a map of the location and an indication of each of the plurality of extracted emotions.

16. The system of claim 15, wherein the data describing the plurality of users comprises: (i) messages generated by the users, (ii) user profiles of the plurality of users, (iii) the biometric data generated by a plurality of biometric sensors, and (iv) social media publications generated by the plurality of users.

17. The system of claim 16, the operation further comprising:
computing an emotion score for each of the plurality of users, wherein the emotion score is based on: (i) the natural language processing applied to the received data of each user, and (ii) the biometric sensor data of each user; and
associating the emotion score with a respective emotion of the plurality of emotions based on a mapping between a range of emotion scores and each respective emotion.

18. The system of claim 17, wherein the graphical representation further comprises a generated graph reflecting flow of a keyword from at least a first user of the plurality of users to a second user of the plurality of users, wherein the keyword is associated with one of the plurality of emotions extracted from the received data describing the plurality of users.

19. The system of claim 18, wherein the request further specifies: (i) a first emotion of the plurality of emotions and (ii) a first grouping criterion of a plurality of grouping criteria, the operation further comprising:
identifying a first subset of the plurality of users based on: (i) each user in the first subset having an attribute satisfying the first grouping criterion, and (ii) each user in the first subset having the first emotion extracted from the respective user data;
grouping each user of the first subset into a group defined by the first grouping criterion; and
outputting an indication of the first group and the first emotion on the emotion map.

20. The system of claim 15, wherein the request is received by an instance of a software as a service (SaaS) application programming interface (API) executing in a cloud computing environment, the operation further comprising:
prior to receiving the data describing the users, transmitting an indication to provide data describing the users to each of the plurality of mobile devices, wherein the transmitted indication specifies the location received in the request, wherein each of the plurality of mobile devices is configured to determine whether the respective device is within a predefined distance of the location and transmit the data describing the users upon determining that the respective device is within the predefined distance of the location.
